(19) United States
(12) Patent Application Publication
(10) Pub. No.: US 2026/0034800 A1
(43) Pub. Date: Feb. 5, 2026

(54) INKJET RECORDING APPARATUS

(71) Applicant: KYOCERA Document Solutions Inc., Osaka (JP)

(72) Inventor: Erika TANAKA, Osaka (JP)

(73) Assignee: KYOCERA Document Solutions Inc., Osaka (JP)

(21) Appl. No.: 19/277,093

(22) Filed: Jul. 22, 2025

(30) Foreign Application Priority Data
Aug. 5, 2024 (JP) 2024-129152

(51) Int. Cl. B41J 2/21; B41J 2/045

(52) U.S. Cl. CPC B41J 2/2114; B41J 2/04501

(57) ABSTRACT

An inkjet recording apparatus includes a conveyance portion, a recording portion, an application portion, and a control portion. The conveyance portion conveys a recording medium. The recording portion has a recording head that ejects aqueous ink onto the recording medium conveyed by the conveyance portion. The application portion is arranged upstream of the recording portion with respect to the conveyance direction of the recording medium and applies a pretreatment liquid to the recording medium. The control portion controls the application of the pretreatment liquid to the recording medium by the application portion. The pretreatment liquid contains at least polyester resin, a surfactant, a water-soluble organic solvent, and water. The control portion changes the application amount of the pretreatment liquid by the application portion according to the surface tension of the recording medium.

### INCORPORATION BY REFERENCE

This application is based on and claims the benefit of priority from Japanese Patent Application No. 2024-129152 filed on Aug. 5, 2024, the contents of which are hereby incorporated by reference.

### BACKGROUND

The present disclosure relates to an inkjet recording apparatus that records images by ejecting ink onto a recording medium.

As recording apparatuses such as facsimile machines, copiers, and printers, inkjet recording apparatuses, which record images by ejecting ink onto a recording medium, are widely used for their capability of forming high-definition images.

In such inkjet recording apparatuses, aqueous pigment ink that uses a pigment as a colorant for its excellent weather resistance is the mainstream. Inconveniently, aqueous pigment ink has a drawback of, when ejected onto a recording medium with low wettability such as a plastic sheet, being prone to cause repelling of and blotting with the ink.

### SUMMARY

According to one aspect of the present disclosure, an inkjet recording apparatus includes a conveyance portion, a recording portion, an application portion, and a control portion. The conveyance portion conveys a recording medium. The recording portion has a recording head that ejects aqueous ink onto the recording medium conveyed by the conveyance portion. The application portion is arranged upstream of the recording portion with respect to the conveyance direction of the recording medium and applies a pretreatment liquid to the recording medium. The control portion controls the application of the pretreatment liquid to the recording medium by the application portion. The pretreatment liquid contains at least polyester resin, a surfactant, a water-soluble organic solvent, and water. The control portion changes the application amount of the pretreatment liquid by the application portion according to the surface tension of the recording medium.

### BRIEF DESCRIPTION OF THE DRAWINGS

FIG. 1 is a schematic diagram showing the structure of an inkjet recording apparatus of the present disclosure.

FIG. 2 is an enlarged view of and around an application portion and a recording portion in FIG. 1.

FIG. 3 is a diagram showing an image obtained when one-dot lines were printed at 600 dpi using aqueous ink with no pretreatment liquid applied to a sheet.

FIG. 4 is a diagram showing an image obtained when one-dot lines were printed at 600 dpi using aqueous ink with a pretreatment liquid applied to a sheet.

FIG. 5 is a diagram schematically showing the states of ink droplets immediately after landing and after drying with no pretreatment liquid applied to the sheet.

FIG. 6 is a diagram schematically showing the states of ink droplets immediately after landing and after drying with the pretreatment liquid applied to the sheet.

### DETAILED DESCRIPTION

### 1. Pretreatment Liquid

Pretreatment liquid used in an inkjet recording apparatus of the present disclosure adjusts the wettability of a plastic sheet as a recording medium to prevent repelling of and blotting with ink when the inkjet recording apparatus forms an image with aqueous ink containing a pigment dispersion containing pigment and resin, an organic solvent, and water. The pretreatment liquid contains at least polyester resin, a surfactant, a water-soluble organic solvent, and water. The pretreatment liquid used in the inkjet recording apparatus of the present disclosure will be described in detail below.

### (Polyester Resin)

The polyester resin is added for the purpose of giving the recording medium wettability with the pretreatment liquid. This helps prevent repelling of ink droplets that occurs when a recording medium with a low surface tension.

The polyester resin blended in the pretreatment liquid is not particularly limited and can be selected as appropriate for the purpose. Polyester resin obtained by condensation polymerization or condensation copolymerization of a dihydric or a trihydric or higher alcohol component and a divalent or a trivalent or higher carboxylic acid component. Examples of the components used in synthesizing the polyester resin include following alcohol components and carboxylic acid components.

Specific examples of dihydric or trihydric or higher alcohol components include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butantriol, 1,2,5-pentantriol, glycerol, diglycerol, 2-methylpropan triol, 2-methyl-1,2,4-butantriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanecarboxylic acid, 1,2,5-hexanthricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components may be used as ester-forming derivatives such as acids halide, acids anhydride, and lower alkyl esters. Here, the term “lower alkyl” denotes an alkyl group with one to six carbon atoms.

The polyester resin content of (its amount blended in) the pretreatment liquid is preferably 5 mass % or more, and more preferably 5 mass % or more but 20 mass % or less. A polyester resin content less than 5 mass % leads to insufficient wet spreading of ink with a recording medium with a low surface tension.

### (Surfactant)

The surfactant is added to improve the wettability of the pretreatment liquid to the recording medium. The amount of surfactant added is preferably 0.001 to 5 mass % of the entire treatment liquid, and more preferably 0.05 to 2 mass %. 0.001 mass % or more of it achieves the effect of adding the surfactant. On the other hand, adding more than 5 mass % of it is not expected to increase the effect.

Usable as the surfactant are various surfactants such as a silicone surfactant, nonionic surfactant, anionic surfactant, cationic surfactant, and betaine surfactant, among which a nonionic surfactant is preferred. As a nonionic surfactant, an acetylene glycol surfactant, which have an acetylene group at the center and which has a symmetrical structure, is preferred because it does not easily foam while it gives wettability. One of those surfactants may be used singly or two or more in combination.

### (Water-Soluble Organic Solvent)

The water-soluble organic solvent is added to increase compatibility with polyester resin and to retain water in the pretreatment liquid. Thus, when the moisture in the pretreatment liquid evaporates in a nozzle for the pretreatment liquid or in an application device, it is possible to suppress an increase in the viscosity of the pretreatment liquid and, even when the pretreatment liquid is applied by the inkjet method, it is possible to prevent the ejection failure or bent ejection from the nozzle and the like. It is thus possible to keep ejection stability.

Examples of water-soluble organic solvents include polyhydric alcohols, polyhydric alcohol alkyl ethers, polyhydric alcohol aryl ethers, nitrogen-containing heterocyclic compounds, amides, amines, sulfur-containing compounds, propylene carbonate, and ethylene carbonate. Among these, those with an equilibrium moisture content of 30 mass % or more are preferred, and those with an equilibrium moisture content of 40 mass % are more preferred. Polyhydric alcohols are especially preferred, examples of which include ethylene glycol, polyethylene glycol, propylene glycol, dipropylene glycol, tripropylene glycol, polypropylene glycol, 3-methyl-1,3-butanediol, 1,5-pentanediol, 2-methyl-2,4-pentanediol, hexylene glycol, 1,6-hexanediol, 1,2,6-hexanediol, trimethylolethane, trimethylolpropane, diethylene glycol, triethylene glycol, tetraethylene glycol, 1,3-butanediol, glycerin, diglycerin, 1,2,3-butanetriol, and 1,2,4-butanetriol. Among these, propylene glycol and 1,3-butanediol are particularly preferred because they have low viscosity when moistened and can hold polyester resin stably with no agglomeration.

Specific examples of polyhydric alcohol alkyl ethers include ethylene glycol monoethyl ether, ethylene glycol monobutyl ether, diethylene glycol monomethyl ether, diethylene glycol monoethyl ether, diethylene glycol monobutyl ether, ethylene glycol mono-2-ethylhexyl ether, propylene glycol monoethyl ether, and the like. Specific examples of polyhydric alcohol aryl ethers include ethylene glycol monophenyl ether, ethylene glycol monobenzyl ether, and the like. Specific examples of nitrogen-containing heterocyclic compounds include 2-pyrrolidone, N-methyl-2-pyrrolidone, 1,3-dimethyl-2-imidazolidinone, epsilon-caprolactam, gamma-butyrolactone, and the like.

The amount of water-soluble organic solvent added is not particularly limited, while 5 to 40 mass % of it in the entire pretreatment liquid is preferred, and 10 to 30 mass % of it is more preferred. Adding 5 to 40 mass % of it helps retain sufficient moisture in the pretreatment liquid and provides a viscosity that is not too high. This allows effective application to the recording medium.

### (Water)

The pretreatment liquid used in the present disclosure is aqueous and contains water as an essential component. The water contained in the pretreatment liquid is not particularly limited so long as it does not spoil the effect of the present disclosure and water of desired purity such as purified water or ion-exchange water can be selected as appropriate. The water content of the pretreatment liquid is not particularly limited so long as it does not spoil the effect of the present disclosure and can be changed as appropriate according to the amounts of other components used, which will be described later. The water content of the pretreatment liquid is preferably 50 to 90 mass % of the total mass of the pretreatment liquid.

The pretreatment liquid used in the present disclosure may contain materials known to be used in treatment liquids such as a foam suppressor, pH adjuster, antiseptic mildewproofing agent, and rust inhibitor as necessary.

### (Foam Suppressor)

The foam suppressor is added to suppress the foaming of the pretreatment liquid. In general, a liquid with a high surface tension such as water is difficult to foam because of the force acting to make the surface area of the liquid as small as possible; a liquid with a low surface tension and a high viscosity easily foams and the foam generated is difficult to defoam. The pretreatment liquid of the present disclosure, by containing polyester resin, a water-soluble organic solvent, a surfactant, and the like, has a reduced surface tension and an increased viscosity and thus easily foam; it is therefore preferable to add the foam suppressor. The amount of foam suppressor added is preferably 0.01 to 10 mass %, and more preferably 0.02 to 5 mass %. 0.01 mass % or more of it achieves the effect of suppressing foam. If 10 mass % or less, the foam suppressor will not be insoluble in the pretreatment liquid.

### (pH Adjuster)

The pH adjuster is not particularly limited and can be selected as appropriate to suit the purpose so long as it can adjust the pH to six to ten without adversely affecting the pretreatment liquid. With a pH of six or higher, conveyance components such as conveyance rollers that make contact with the pretreatment liquid are less likely to corrode.

Preferable pH adjusters include alcohol amines, alkali metal hydroxides, ammonium hydroxides, phosphonium hydroxides, and carbonates of alkali metals. Alcohol amines include, for example, diethanolamine, triethanolamine, and 2-amino-2-ethyl-1,3-propanediol. Alkali metal hydroxides include, for example, lithium hydroxide, sodium hydroxide, and potassium hydroxide. Ammonium hydroxides include, for example, ammonium hydroxide and quaternary ammonium hydroxide. Phosphonium hydroxides include, for example, quaternary phosphonium hydroxides. Alkali metal carbonates include, for example, lithium carbonate, sodium carbonate, and potassium carbonate.

### (Antiseptic Mildewproofing Agent)

Suitably usable as the antiseptic mildewproofing agent is, for example, sodium dehydroacetate, sodium sorbate, sodium 2-pyridinethiol-1-oxide, sodium benzoate, sodium pentachlorophenol, and sodium 1,2-benzoisothiazolin-3-one.

### (Rust Inhibitor)

Suitably usable as the rust inhibitor is, for example, acidic sulfites, sodium thiosulfate, ammonium thiodiglycolate, diisopropyl ammonium nitrite, dicyclohexyl ammonium nitrite, pentaerythritol tetranitrate, and 1,2,3-benzotriazole.

The pretreatment liquid of the present disclosure obtained as described above is applied to the recording medium before being subjected to recording with aqueous ink (pigment ink) by the inkjet method to improve the wettability (wet tension) of the surface of the recording medium. This helps prevent repelling of and blotting with aqueous ink ejected onto the recording medium.

The applied amount of pretreatment liquid is not particularly limited, but if the amount applied is less than 1 g/m², the wettability (wet tension) of the surface of the recording medium cannot be sufficiently improved and the effect of preventing repelling of and blotting with aqueous ink is insufficient. In contrast, if the amount applied is more than 20 g/m², the wettability (wet tension) of the surface of the recording medium is too high and the pretreatment liquid does not dry in time, so it may cause blotting with aqueous ink. Thus, the applied amount of pretreatment liquid is preferably 1 g/m² or more but 20 g/m² or less, and more preferably 5 g/m² or more but 10 g/m² or less.

### 2. Image Recording Method

Next, an image recording method using an inkjet recording apparatus will be described. The inkjet recording apparatus used in the image recording method of the present disclosure is not particularly limited: a serial-head or line-head inkjet recording apparatus can be used. In particular, on an inkjet recording apparatus using aqueous pigment ink, when using a plastic sheet as a recording medium, repelling of and blotting with ink tend to occur, but these problems are less likely to occur with the image recording method of the present disclosure.

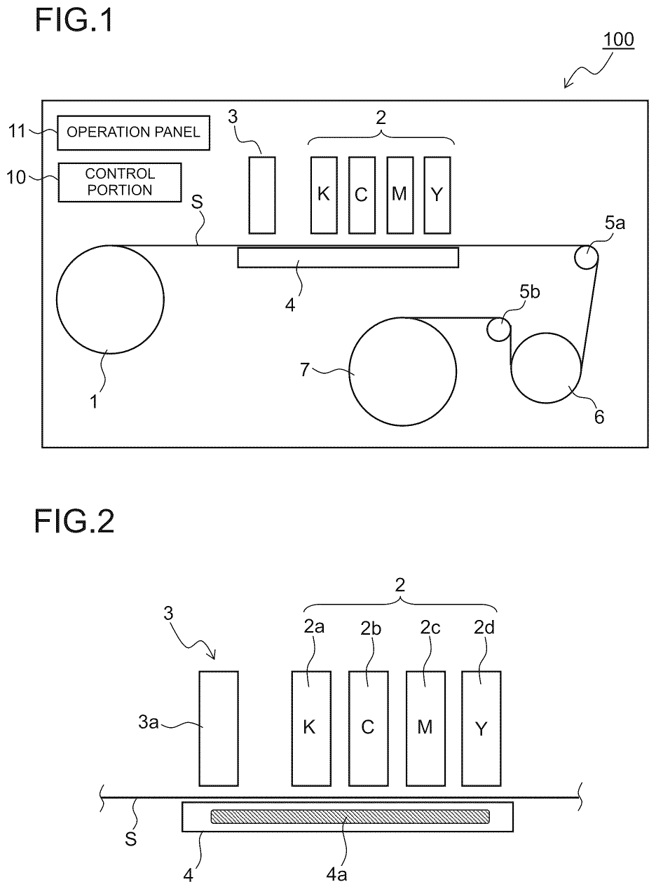

FIG. 1 is a schematic diagram showing the structure of an inkjet recording apparatus 100 according to one embodiment of the present disclosure. FIG. 2 is an enlarged view of and around a recording portion 2 and an application portion 3 in FIG. 1. As shown in FIG. 1, the inkjet recording apparatus 100 includes a sheet reel-out portion 1, the recording portion 2, the application portion 3, a conveyance plate 4, a heating drum 6, a sheet reel-in portion 7, a control portion 10, and an operation panel 11.

A sheet S which is an elongate printing base material (here, a plastic sheet) is arranged in the sheet reel-out portion 1 provided upstream (left in FIG. 1) of the recording portion 2 in the conveyance direction. The sheet reel-out portion 1 includes a rotation shaft on which a sheet S in the form of a roll is mounted and a motor that drives the rotation shaft to rotate in a predetermined rotation direction (neither is shown). The sheet S is reeled out downstream (right in FIG. 1) in the conveyance direction as the rotation shaft rotates by being driven by the motor.

The recording portion 2 includes recording heads 2a, 2b, 2c, and 2d (see FIG. 2). The recording heads 2a to 2d are supplied with, according to the colors for which they are intended, inks of four colors (yellow, magenta, cyan, and black) stored in ink tanks (not shown) respectively. Using the recording heads 2a to 2d, the recording portion 2 records an image on the sheet S reeled out from the sheet reel-out portion 1.

The application portion 3 is arranged upstream (left in FIG. 1) of the recording portion 2 in the sheet conveyance direction. The application portion 3 includes a pretreatment liquid ejection head 3a. The pretreatment liquid ejection head 3a has a similar structure to the recording heads 2a to 2d and ejects the pretreatment liquid, described previously, by the inkjet method onto the sheet S reeled out from the sheet reel-out portion 1.

Below the recording portion 2 and the application portion 3, the conveyance plate 4 is arranged. The sheet S reeled out from the sheet reel-out portion 1 is supported by the conveyance plate 4 at a predetermined interval from the recording portion 2 and the application portion 3. A heater 4a is arranged at the back side of the conveyance plate 4 (the side opposite from the recording portion 2 and the application portion 3). The sheet S is heated by the heater 4a from its back side while being conveyed along the conveyance plate 4. Thus, before ink is ejected from the recording portion 2, the pretreatment liquid ejected by the application portion 3 onto the sheet S is dried. The heater 4a may be of any type, such as a halogen heater, ceramic heater, high-frequency induction heating (IH), and hot water heater.

The sheet S having passed through the recording portion 2 has its conveyance direction changed by a guide roller 5a and is then conveyed to the heating drum 6. The sheet S makes contact with the heating drum 6 so that the ink is dried and fixed to the sheet S. The sheet S having the ink fixed to it has its conveyance direction changed by a guide roller 5b and is then reeled into the form of a roll by the sheet reel-in portion 7. In this embodiment, the ink is dried with the heating drum 6, but any other drying device, such as an infrared dryer or hot air dryer, may be used instead.

The control portion 10 controls the ejection of ink by the recording portion 2 according to image data received from an external computer. The control portion 10 determines whether to eject the pretreatment liquid and the amount of it to eject in the application portion 3 as will be described later.

The operation panel 11 functions as a touch panel for the user to make various settings and inputs for the inkjet recording apparatus 100, while it displays the status of the inkjet recording apparatus 100, the progress of image recording, the number of sheets printed, and the like.

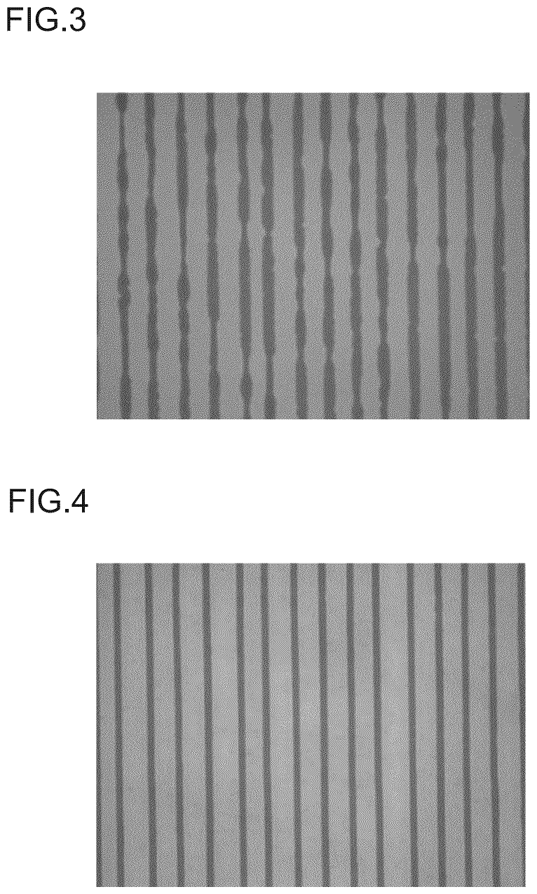

FIG. 3 is a diagram showing an image obtained when one-dot lines were printed at 600 dpi using aqueous ink with no pretreatment liquid applied to a sheet S. FIG. 4 is a diagram showing an image obtained when one-dot lines were printed at 600 dpi using aqueous ink with the pretreatment liquid applied to a sheet S.

As shown in FIG. 3, with no pretreatment liquid applied to the sheet S, the line width was uneven, being thicker or thinner from place to place. By contrast, as shown in FIG. 4, with the pretreatment liquid applied to the sheet S, the line width was uniform.

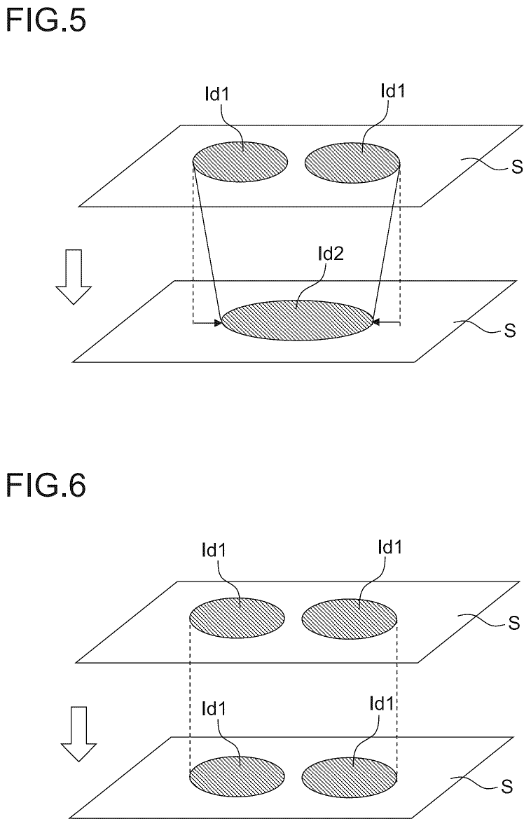

FIGS. 5 and 6 are each a diagram schematically showing the states of ink droplets immediately after landing and after drying, with no pretreatment liquid applied and with the pretreatment liquid applied, respectively, to the sheet S. As shown in FIG. 5, when no pretreatment liquid is applied to the sheet S and hence the wet tension of the sheet S is low, ink droplets Id1 ejected close together attract each other and form one large ink droplet Id2 (merge into one). Thus, the ink droplets have uneven sizes and the lines have uneven widths as shown in FIG. 3.

By contrast, as shown in FIG. 6, when the pretreatment liquid is applied to the sheet S, the wet tension of the sheet S is high, and so the ink droplets Id1 do not merge into one, with no change in the size of the ink droplet. Thus, the lines have a uniform width as shown in FIG. 4.

The control portion 10 determines whether to apply the pretreatment liquid and the amount of it to apply in the application portion 3 according to the wet tension of the sheet S. Specifically, a table that stores the correspondence between different types of sheet S and their surface tensions (wet tensions) is stored in a storage portion (not shown) in advance. At the start of printing, the type of sheet S to be used is input from the operation panel 11 on the inkjet recording apparatus 100. The control portion 10 reads the surface tension corresponding to the input type of sheet S from the table stored in the storage portion and determines whether to apply the pretreatment liquid and the amount of it to apply in the application portion 3 based on the read surface tension.

It is thus possible to adjust the wet tension of the sheet S within an optimal range and thus to prevent repelling of and blotting with ink to obtain satisfactory images. If the wet tension of the sheet S is high, no pretreatment liquid is applied, so it is possible to prevent unnecessary consumption of the pretreatment liquid.

When the surface tension of the sheet S is 45 mN/m or less, it is preferable to apply the pretreatment liquid to the sheet S in the application portion 3. Preferably, as the surface tension of the sheet S decreases, the amount of pretreatment liquid to apply is increased.

With the image reading method described above, to a sheet before the inkjet recording apparatus 100 forms an image with aqueous ink, the pretreatment liquid containing polyester resin is applied. This improves the wettability (wet tension) of the sheet to prevent repelling of and blotting with aqueous ink and thereby to enhance image quality. It is thus possible to use the image recording method of the present disclosure suitably on various inkjet recording apparatuses that use aqueous ink.

The present disclosure can be implemented in any manner other than as in the embodiment described above, and allows for any modifications within the scope defined in the appended claims. For example, while FIG. 1 illustrates an inkjet recording apparatus 100 that ejects ink while reeling out an elongate sheet S in the form of a roll at a predetermined speed and, the present disclosure is applicable equally to an inkjet recording apparatus that ejects ink onto sheets cut in a predetermined shape.

While the above embodiment deals with a configuration where the pretreatment liquid is ejected by the inkjet method from a pretreatment liquid ejection head 20, it can be applied by any method other than the inkjet method, for example, by a spray method, as long as it can be applied uniformly to the sheet S.

The material of the recording medium is not limited to plastic film; it can be any of a variety of recording media including paper such as plain paper and coated paper and fabrics such as natural or synthetic fiber fabric, knitted fabric, or non-woven fabric. The effects of the present disclosure will be described more specifically below by way of examples, which, however, are not meant to restrict the present disclosure.

### EXAMPLES

### Manufacturing Example 1

### (Preparation of Pigment Dispersion)

75 g of pigment dispersion resin (DISPERBYK-190, manufactured by BYC Chemie Japan; non-volatile content: 40 mass %, dispersant: water) was diluted with 775 g of ion-exchange water, and 150 g of pigment (Pigment Blue 15:03) was added. The mixture was then pre-mixed with Homo Disper at a rotation rate of 5000 rpm for 1 hour. It was then subjected to dispersion using a bead mill (manufactured by Nippon Coke & Engineering Co., Ltd.) to obtain a pigment dispersion. The vessel was loaded with zirconia beads (0.2 mmφ) at a filling ratio of 80% to the volume. The diameter of the dispersion particles was Z-ave. 101 nm.

### Manufacturing Example 2

### (Preparation of Ink)

5 mass parts of the pigment dispersion obtained in Manufacturing Example 1, 3 mass parts of binding resin (HA560, manufactured by NICCA Chemical Co., Ltd.), 0.04 mass parts of surfactant (SAG-502A, manufactured by Nisshin Chemical Co., Ltd.), 25 mass parts of propylene glycol, 8 mass parts of butyl triglycol, and 58.96 mass parts of water were mixed together to prepare pigment ink I-1.

Ink I-2 was prepared in the same way as the ink I-1, except that the binding resin was changed to Superflex 130 (manufactured by DKS Co., Ltd.).

### Manufacturing Example 3

### (Preparation of Pretreatment Liquid)

10 mass % of polyester resin A (Pesresin A-640, manufactured by Takamatsu Oil & Fat Co., Ltd.; number average molecular weight: 17,000, glass transition point: 64° C., solid content: 25 mass %, viscosity: less than 50 mPa-s), 0.04 mass % of surfactant (Surfynol 440, manufactured by Nisshin Chemical Co., Ltd.), 25 mass % of propylene glycol, 64.96 mass % of ion-exchange water were stirred in a stirrer to prepare pretreatment liquid 1.

Pretreatment liquid 2 was prepared in the same way as the pretreatment liquid 1, except that polyester resin B (Elitel KA-5034, manufactured by Unitika Ltd.; average molecular weight: 9,000, glass transition point: 67° C., solid content: 30 mass %, viscosity: 10 to 100 mPa-s) was used instead of polyester resin A. Pretreatment liquids 3 to 5 were also prepared in the same way as the pretreatment liquid 1, except the amount of polyester resin A blended was varied.

Pretreatment liquid 6 was prepared in the same way as the pretreatment liquid 1, except that acrylic resin (Movinyl 6820, manufactured by Japan Coating Resin Co., Ltd; glass transition point: 71° C., solid content: 50 mass %, viscosity: 50-1000 mPa-s) was used instead of polyester resin A. Pretreatment liquid 7 was prepared in the same way as the pretreatment liquid 1, except that 1,3-propanediol was used instead of propylene glycol. The compositions of pretreatment liquids 1 to 7 are shown in Table 1.

TABLE 1

| | Pretreatment | Pretreatment | Pretreatment | Pretreatment | Pretreatment | Pretreatment | Pretreatment |
|---|---|---|---|---|---|---|---|
| Materials | Liquid 1 | Liquid 2 | Liquid 3 | Liquid 4 | Liquid 5 | Liquid 6 | Liquid 7 |
| Polyester | 10 | — | 20 | 5 | 3 | — | 10 |
| Resin A | | | | | | | |
| Polyester | — | 10 | — | — | — | — | — |
| Resin B | | | | | | | |
| Acrylic | — | — | — | — | — | 10 | — |
| Resin | | | | | | | |
| Surfactant | 0.04 | 0.04 | 0.04 | 0.04 | 0.04 | 0.04 | 0.04 |
| Propylene | 25 | 25 | 25 | 25 | 25 | 25 | — |
| Glycol | | | | | | | |
| 1,3- | — | — | — | — | — | — | 25 |
| propanediol | | | | | | | |
| Water | 64.96 | 64.96 | 54.96 | 69.96 | 71.96 | 64.96 | 64.96 |

### Evaluation of Line Width Uniformity

Using pigment inks (cyan ink) I-1 and I-2 of Manufacturing Example 2 and pretreatment liquids 1 to 7 of Manufacturing Example 3, images were formed to evaluate the uniformity of line width. The testing machine used for the evaluation included inkjet heads (KJ4B-YH, manufactured by Kyocera Corporation) for discharging the pigment ink and the pretreatment liquid, respectively, along with a conveyance table below the inkjet heads for conveying a printing base material (sheet). The conveyance table was heatable to a predetermined temperature.

### <Evaluation Method>

Using the testing machine described above, printing was performed under the following conditions: head applied voltage, 21 V; drive frequency, 20 kHz; amount of ejected liquid, 3 pl; print head temperature, 32° C.; print head resolution, 600 dpi; and number of flushing before ejecting, 1000 times. The conveyance table for the print medium was heated to 40° C. in advance. The conveyance speed of the print medium was set at 30 m/min. Then, one-dot lines were printed at 600 dpi on the printing base material having the pretreatment liquid applied to it, under the prescribed conditions (system conditions). After that, through drying in a warm-air dryer at 80° C. for 120 seconds, a print result was obtained. The obtained print result was visually inspected to evaluate line width uniformity according to the following evaluation criteria.

### (Evaluation Criteria)

Good: uniform line width.
Poor: uneven line width.

The system conditions and printing base materials used are shown in Tables 2 and 3, respectively. The results of evaluation of line width uniformity are shown in Tables 4 and 5, along with the types of printing base materials, inks, and pretreatment liquids, and the application amounts of pretreatment liquid used.

TABLE 2

| | |
|---|---|
| Condition 1 | Pretreatment liquid applied for printing base materials |
| | with a surface tension of 45 mN/m or less, and not for |
| | those with a surface tension of 45 mN/m or more. |
| Condition 2 | Pretreatment liquid applied for printing base materials |
| | with a surface tension of 35 mN/m or less, and not for |
| | those with a surface tension of 35 mN/m or more. |
| Condition 3 | No pretreatment liquid applied for printing base |
| | materials with any surface tension. |

TABLE 3

| | | | Surface |
|---|---|---|---|
| | Type of | | Tension |
| | Resin | Manufacturer/Product Name | [mN/m] |
| Base Material 1 | OPP (*1) | Toray Industries, Inc. | 32.9 |
| | | TORAYFAN 2500H | |
| Base Material 2 | OPP | Toray Industries, Inc. | 38.0 |
| | | TORAYFAN 2548 | |
| Base Material 3 | PET (*2) | Toray Industries, Inc. | 45.3 |
| | | Lumirror S10 | |
| Base Material 4 | PET | Futamura Chemical Co., Ltd. | 47.8 |
| | | FOR-AQ | |

(*1): Biaxially oriented polypropylene
(*2): Polyethylene terephthalate

TABLE 4

| | Present | | Present | | Present | | Present | | Present | | Present | |
|---|---|---|---|---|---|---|---|---|---|---|---|---|
| | Disclosure 1 | | Disclosure 2 | | Disclosure 3 | | Disclosure 4 | | Disclosure 5 | | Disclosure 6 | |
| | System Condition | | | | | | | | | | | |
| | Condition 1 | | Condition 1 | | Condition 1 | | Condition 1 | | Condition 1 | | Condition 1 | |
| | Ink | | | | | | | | | | | |
| | I-1 | | I-1 | | I-1 | | I-1 | | I-2 | | I-1 | |
| | Pretreatment Liquid | | | | | | | | | | | |
| | Pretreatment | | Pretreatment | | Pretreatment | | Pretreatment | | Pretreatment | | Pretreatment | |
| | Liquid 1 | | Liquid 2 | | Liquid 3 | | Liquid 4 | | Liquid 1 | | Liquid 7 | |
| | Application Amount | | | | | | | | | | | |
| | 5 g | 10 g | 5 g | 10 g | 5 g | 10 g | 5 g | 10 g | 5 g | 10 g | 5 g | 10 g |
| Base | Good | Good | Good | Good | Good | Good | Poor | Good | Good | Good | Good | Good |
| Material 1 | | | | | | | | | | | | |
| Base | Good | Good | Good | Good | Good | Good | Poor | Good | Good | Good | Good | Good |
| Material 2 | | | | | | | | | | | | |
| Base | Good | Good | Good | Good | Good | Good | Good | Good | Good | Good | Good | Good |
| Material 3 | | | | | | | | | | | | |
| Base | Good | Good | Good | Good | Good | Good | Good | Good | Good | Good | Good | Good |
| Material 4 | | | | | | | | | | | | |

TABLE 5

| | Comparative | | Comparative | | Comparative | | Comparative | |
|---|---|---|---|---|---|---|---|---|
| | Example 1 | | Example 2 | | Example 3 | | Example 4 | |
| | System Condition | | | | | | | |
| | Condition 1 | | Condition 1 | | Condition 1 | | Condition 1 | |
| | Ink | | | | | | | |
| | I-1 | | I-1 | | I-1 | | I-1 | |
| | Pretreatment Liquid | | | | | | | |
| | Pretreatment | | Pretreatment | | Pretreatment | | Pretreatment | |
| | Liquid 5 | | Liquid 6 | | Liquid 1 | | Liquid 1 | |
| | Application Amount | | | | | | | |
| | 5 g | 10 g | 5 g | 10 g | 5 g | 10 g | 5 g | 10 g |
| Base | Poor | Poor | Poor | Poor | Good | Good | Poor | Poor |
| Material 1 | | | | | | | | |
| Base | Poor | Poor | Poor | Poor | Poor | Poor | Poor | Poor |
| Material 2 | | | | | | | | |
| Base | Good | Good | Good | Good | Good | Good | Good | Good |
| Material 3 | | | | | | | | |
| Base | Good | Good | Good | Good | Good | Good | Good | Good |
| Material 4 | | | | | | | | |

As will be understood from Table 4. when one-dot lines were printed at 600 dpi using ink I-1 or 1-2 on the printing base material having one of pretreatment liquids 1 to 4 and 7 applied to it under system condition 1 (Present Disclosure 1 to 6), if the application amount of pretreatment liquid was 10 g, the line width was uniform in the evaluation of line width uniformity and the surface tension (wet tension) of printing base materials 1 to 4 was increased by the pretreatment liquid. If the application amount of pretreatment liquid was 5 g, in Present Disclosure 4, which used pretreatment liquid 4 containing less, that is, 5 mass % of, polyester resin, the line width on printing base materials 1 and 2 was uneven but, in Present Disclosure 1 to 3, 5, and 6, the line width was uniform.

In contrast, in Comparative Example 1, which used pretreatment liquid 5 containing 3 mass % of polyester resin, and in Comparative Example 2, which used pretreatment liquid 6 containing acrylic resin instead of polyester resin, the line width on printing base materials 1 and 2 was uneven regardless of the applied amounts of pretreatment liquids 5 and 6. The reason for this is considered to be that, in Comparative Example 1, the amount of polyester resin in pretreatment liquid 5 was less than the prescribed amount, and that, in Comparative Example 2, the resin component of pretreatment liquid 6 was not polyester resin, in both cases resulting in insufficient wet spreading of ink on printing base materials 1 and 2 with a low surface tension.

In Comparative Example 3, in which printing was performed under system condition 2, the line width on printing base material 2 was uneven, and in Comparative Example 4, in which printing was performed under system condition 3 with no application of pretreatment liquid 1, the line width on printing base materials 1 and 2 was uneven. The reason for this is considered to be that, in Comparative Example 3, pretreatment liquid 1 was not applied to printing base material 2 with a surface tension of 35 mN/m or more, resulting in insufficient wet spreading of ink on printing base material 2. In Comparative Example 4, pretreatment liquid 1 was not applied to either of printing base materials 1 or 2 with a low surface tension, resulting in insufficient wet spreading of ink on both of printing base materials 1 and 2.

The results of Present Disclosure 1 to 6 and Comparative Examples 1 to 4 confirm that the application of a pretreatment liquid containing 5 mass % or more of polyester resin to the printing base material with a surface tension of 45 mN/m or less can effectively prevent repelling of and blotting with ink droplets in printing with aqueous ink.

The present disclosure is applicable to inkjet recording apparatuses that eject ink onto a recording medium. Based on the present disclosure, it is possible to provide an inkjet recording apparatus that can prevent repelling of and blotting with ink when images are formed with aqueous ink.

What is claimed is:

1. An inkjet recording apparatus, comprising:
a conveyance portion that conveys a recording medium;
a recording portion having a recording head that ejects aqueous ink onto the recording medium conveyed by the conveyance portion;
an application portion arranged upstream of the recording portion with respect to a conveyance direction of the recording medium, the application portion applying a pretreatment liquid to the recording medium;
a control portion that controls application of the pretreatment liquid to the recording medium by the application portion;
wherein
the pretreatment liquid contains at least polyester resin, a surfactant, a water-soluble organic solvent, and water, and
the control portion changes an application amount of the pretreatment liquid by the application portion according to a surface tension of the recording medium.

2. The inkjet recording apparatus according to claim 1, wherein
the pretreatment liquid contains 5 mass % or more of polyester resin.

3. The inkjet recording apparatus according to claim 1, wherein
when the surface tension of the recording medium is 45 mN/m or less, the control portion performs the application of the pretreatment liquid by the application portion.

4. The inkjet recording apparatus according to claim 1, wherein
the application portion is a pretreatment liquid ejection head that ejects the pretreatment liquid by an inkjet method.

5. The inkjet recording apparatus according to claim 1, further comprising:
a heating portion that heats the recording medium passing through the application portion and the recording portion.

6. The inkjet recording apparatus according to claim 5, wherein
the heating portion includes
a conveyance plate that supports a surface of the recording medium opposite from the application portion and the recording portion, and
a heater that heats the conveyance plate.

7. The inkjet recording apparatus according to claim 1. wherein
the recording medium is a plastic film.
